(19) United States
(12) Patent Application Publication
(10) Pub. No.: US 2010/0075725 A1
(43) Pub. Date: Mar. 25, 2010

(54) Internet Telephone

(75) Inventors: Wei-Ming Wu, Taipei (TW); Ker-How Lu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PEGATRON CORPORATION, Taipei (TW)

(21) Appl. No.: 12/567,106

(22) Filed: Sep. 25, 2009

(30) Foreign Application Priority Data
Sep. 25, 2008 (TW) 097136957

(51) Int. Cl. H04M 1/00; H04L 12/66

(52) U.S. Cl. 455/575.1; 370/352

(57) ABSTRACT

An Internet telephone includes a main body and a function module. The main body includes a recess. One side of the function module has a first function section, and the other side has a second function section. The function module is electrically connected with the main body through an end of the first function section while the function module is assembled into the recess and exposes the first function section. Furthermore, the function module can be flipped to expose the second function section before assembling into the recess and electrically connected with the main body through an and of the second function module.

### CROSS-REFERENCE TO RELATED APPLICATIONS

This Non-provisional application claims priority under 35 U.S.C. §119(a) on Patent Application No(s). 097136957 filed in Taiwan, Republic of China Sep. 25, 2008, the entire contents of which are hereby incorporated by reference.

### BACKGROUND OF THE INVENTION

1. Field of the Invention

The invention relates to an Internet telephone and, more particularly, to an Internet telephone having a plurality of function modes.

2. Description of the Related Art

At present, telephone voice communication of a general home telephone or a public telephone is mainly realized by using telephone wires to transmit signals via a public switched telephone network (PSTN) technique. A user needs to pay high cost according to communication time and distance.

With the development of Internet, there are more and more Internet users, and the voice-over-Internet protocol (VoIP) technique becomes mature to lead an Internet telephone to become a common communication tool. In the Internet telephone, a voice signal is first converted to digitized data. The digitized data is then transmitted to a destination via the Internet, and further, the digitized data is converted to voice data at the destination. Thus the user needn't to pay the high communication cost via the Internet telephone. According to the aforementioned, the Internet telephone is convenient and economical.

The Internet telephone can provide more functions than the conventional telephone, for example, the Internet telephone can perform a web browse via different protocols. However, the present telephone operation interface cannot satisfy needs of the Internet telephone with more functions.

### BRIEF SUMMARY OF THE INVENTION

According to one objective of this invention, an Internet telephone having a plurality of function modes for switch to cooperate with different operation needs is provided.

The invention provides an Internet telephone including a main body and a function module. The main body includes a recess. One side of the function module has a first function section, and the other side has a second function section. The function module is electrically connected with the main body through an end of the first function section while the function module is assembled into the recess and exposes the first function section. Furthermore, the function module can be flipped to expose the second function section before assembling into the recess and electrically connected with the main body through an end of the second function module.

The first function section may include a dial key. The second function section may include an input interface, and the input interface may be selected from the group consisting of a QWERTY keyboard, a touchpad, a direction key, and a combination thereof. The second function section may also include a mini USB port or a solid hard disk.

The function module may include a plurality of connection pins disposed at the side and the other side of the function module, respectively. The connection pins may include at least one fool-proof pin for distinguishing the first function section from the second function section. The Internet telephone may further include an antenna module. The main body may include a slot. The antenna module may be assembled into the slot. The antenna module may be a wireless receiving module, such as a wireless local area network (LAN) antenna module, a global positioning system (GPS) antenna module, or a bluetooth transmission antenna module. The antenna module may include a camera. The Internet telephone may further include a fastener disposed at one side of the slot for fastening the antenna module to the slot. The Internet telephone may include a fastener disposed at one side of the recess for fastening the function module to the recess.

According to the Internet telephone in the invention, two sides of the function module have different functions, and the function module can be flipped to switch between the first function section and the second function section in cooperation with needs of users before assembled. In addition, different types of the Internet telephones can use the same main body by replacing the antenna module so as to reduce the manufacturing cost. Thus, the user can expand the operating function of the Internet telephone by replacing the antenna module or selecting the function module.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing an Internet telephone according to one preferred embodiment of the invention;

FIGS. 2A to 2D are schematic diagrams showing two opposite surfaces of a function module of an Internet telephone according to different embodiments of the invention;

FIG. 3 is a schematic diagram showing an Internet telephone according to another preferred embodiment of the invention; and

FIGS. 4A and 4B are schematic diagrams showing an antenna module of an Internet telephone according to different embodiments of the invention.

### DETAILED DESCRIPTION OF THE INVENTION

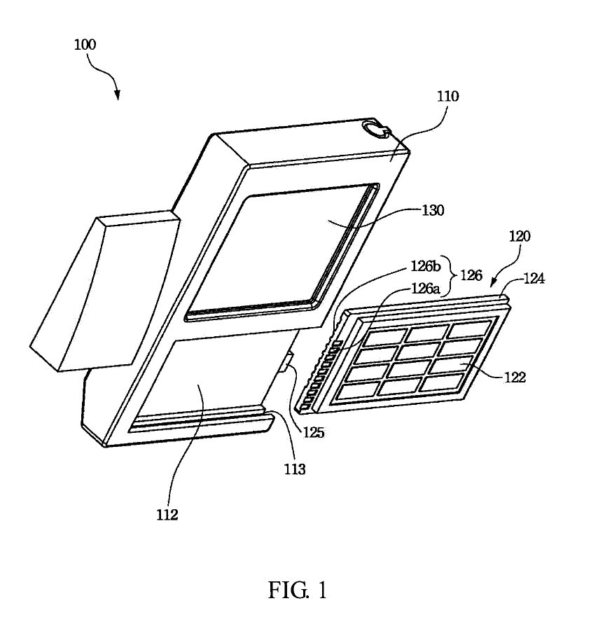

FIG. 1 is a schematic diagram showing an Internet telephone according to one preferred embodiment of the invention. Please refer to FIG. 1, an Internet telephone 100 includes a main body 110, a function module 120 and a display panel 130. The main body 110 includes a recess 112, and the function module 120 can be assembled into the recess 112.

One side of the function module 120 has a first function section 122, and the other side has a second function section (not shown). The first function section 122 and the second function section have different functions for switch in cooperation with different needs of users. The function module 120 is electrically connected with the main body 110n through an end of the first function section 122 while the function module 120 is assembled into the recess 112 and exposes the first function section 122. If the second function section is to be used, the function module 120 can be taken away from the recess 112, and the function module 120 is flipped to expose the second function section at the other side and electrically connected with the main body 110 through an end of the second function section.

The function module 120 includes a plurality of connection pins 126. The connection pins 126 include first connection pins 126a disposed at one side of the function module 120 and second connection pins 126b disposed at the other side of the function module 120, such that the first function section 122 and the second function section can be electrically connected with the main body 110 via the first connection pins 126a and the second connection pins 126b, respectively.

In this embodiment, the first connection pins 126a and the second connection pins 126b have the same relative position at the function module 120 so that the first connection pins 126a or the second connection pins 126b can be selectively connected with the main body 110 according to the side or the other side of the function module is flipped to be faceup. The first connection pins 126a and the second connection pins 126b can have a fool-proof pin respectively for the main body 110 to distinguish the first function section 122 from the second function section. In other embodiments, the pin number of the first connection pins 126a may be different from that of the second connection pins 126b, or the first connection pins 126a and the second connection pins 126b may be disposed at non-corresponding positions of the function module 120 so that the main body 110 can distinguish the first function section 122 from the second function section according to the aforementioned.

The recess 112 includes sliding rails 113, and the function module 120 has sliding blocks 124. The sliding block 124 of the function module 120 can be assembled into the recess 112 along the sliding rail 113, and further, the engagement of the sliding block 124 and the sliding rail 113 limit the movement of the function module 120 in a vertical direction. The Internet telephone 100 further includes a fastener 125 disposed at one side of the recess 112. When the function module 120 is assembled, the fastener 125 is released to let the function module 120 slide out of the recess 112. The fastener 125 is then locked to fasten the function module 120 to the recess 112 after the function module 120 is assembled.

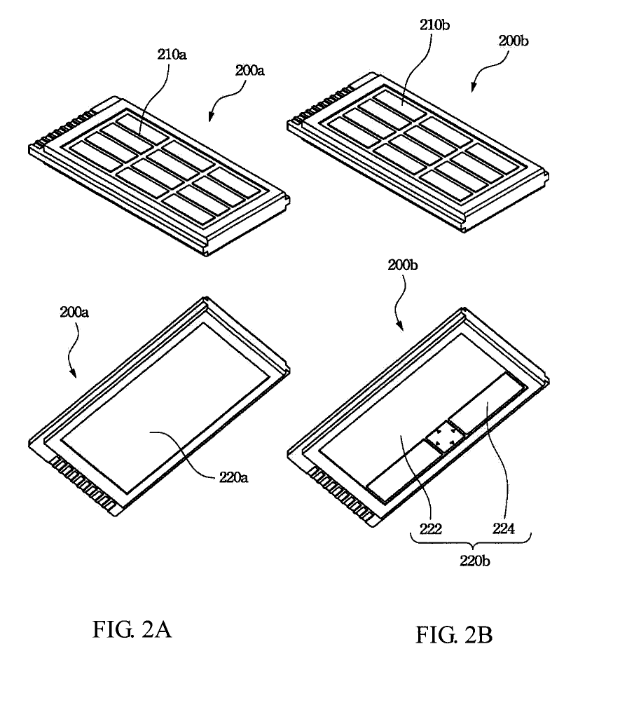

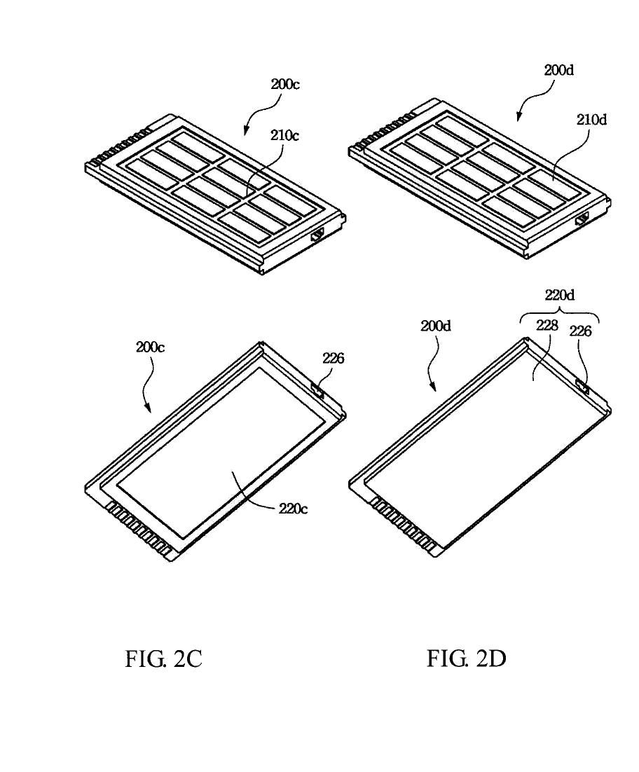

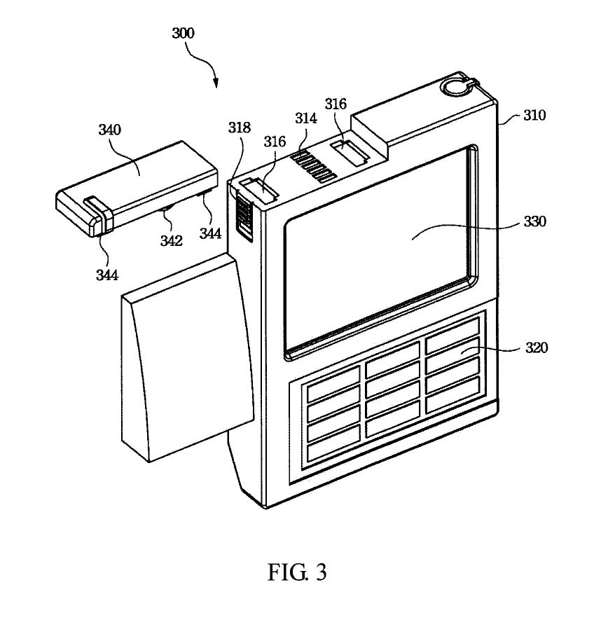

FIGS. 2A to 2D are schematic diagrams showing two opposite sides of a function module of an Internet telephone according to different embodiments of the invention. In FIG. 2A, one side of a function module 200a has a first function section 210a, and the other side has a second function section 220a. The first function section 210a includes a dial key, and the second function section 220a includes a QWERTY board. A user can use a dial keyboard of the first function section 210a while the user dials; and further, the user can extract and flip the function module 200a to switch to the second function section 220a while the user needs to input characters or perform other operations.

In FIG. 2B, the first function section 210b at the side of the function module 200b includes a dial key, and the second function section 220b at the other side includes a touchpad 222 and a direction key 224. A user can use a dial key of the first function section 210a while the user dials; and further, the user can flip the function module 200b to switch to the second function section 220b while the user needs to perform the operation such as a web browse.

In FIG. 2C, the first function section 210c at one side of the function module 200c has a dial key, and the second function section 220c at the other side includes a mini USB port 226. A user can use a dial key of the first function section 210a while the user dials; and further, the user can flip the function module 200c to switch to the second function section 220c while the user needs to perform other operations through an external expansion equipment. Thus, the Internet telephone can be connected with the external expansion equipment via the mini USB port 226.

In FIG. 2D, the first function section 210d at one side of the function module 200d includes a dial key, and the second function section 220d at the other side includes a mini USB port 226 and a solid hard disk 228. A user can use a dial key of the first function section 210a while the user dials; and further, the function module 200d can be flipped to switch to the second function section 220d so that the user can use the mini USB port 226 of the second function section 220d in cooperation with an adaptor to expand different external devices and to keep downloaded data in the solid hard disk 228.

FIG. 3 is a schematic diagram showing an Internet telephone according to another preferred embodiment of the invention. Please refer to FIG. 3, an Internet telephone 300 includes a main body 310, a function module 320, a display panel 330 and an antenna module 340. The main body 310 includes two slots 316. The antenna module 340 can be plugged into or released from the slots 316. The Internet telephone 300 can use different antenna modules 340 according to different needs of users.

One side of the antenna module 340 facing the main body 310 has a conductive elastic sheet 342 for electrically connecting a contacting terminal 314 of the main body 310. The side of the antenna module 340 facing the main body 310 has two protrudent blocks 344, and the antenna module 340 is fastened to the slots 316 of the main body 310 through the blocks 344. The Internet telephone 300 further includes a fastener 318 disposed at one side of the slot 316. The fastener 318 is released when the antenna module 340 is replaced; and further, the fastener 318 is locked again to fasten the antenna module 340 to the slots 316 after the antenna module 340 is assembled.

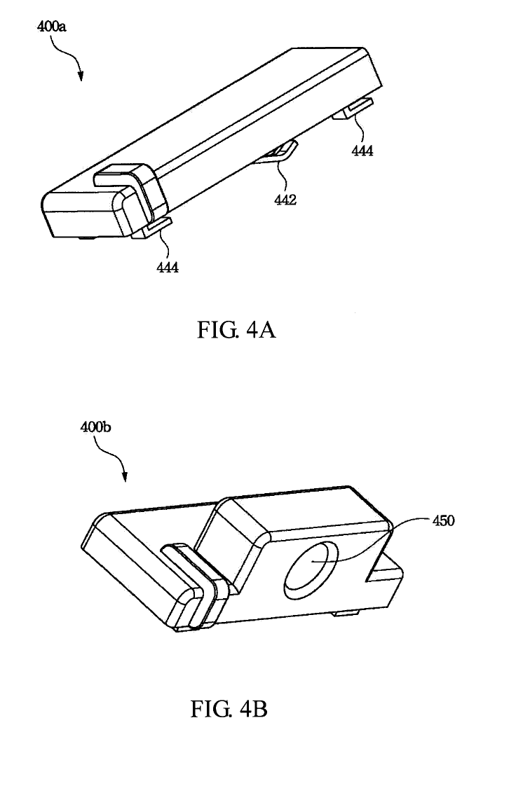

FIGS. 4A and 4B are schematic diagrams showing an antenna module of an Internet telephone according to different embodiments of the invention. In FIG. 4A, the antenna module 400a is a wireless receiving module. As the Internet telephone is an indoor device, the antenna module 400a may be a wireless local area network (LAN) antenna module which can be fastened to a main body (not shown) via protrudent blocks 444 and be electrically connected with the main body via a conductive elastic sheet 442. Otherwise, the antenna module 400a may be a global positioning system (GPS) antenna module as the Internet telephone is an outdoor device. On the other hand, the antenna module 400a may be a bluetooth transmission antenna module for transferring data. In FIG. 4B, an antenna module 400b can include a camera 450 for video communication in cooperation with the Internet telephone.

According to the above preferred embodiments of the invention, in the Internet telephone, two sides of the function module have different functions; and further, the function module can be flipped to expose the first function section or the second function section before the function module is assembling into the main body for switching the first function section and the second function section in cooperation with operation needs of users.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An Internet telephone comprising:
a main body including a recess; and
a function module, one side of the function module having a first function section, the other side of the function module having a second function section, the function module being electrically connected with the main body through an end of the first function section while the function module is assembled into the recess and exposes the first function section,
wherein the function module can be flipped to expose the second function section before assembling into the recess and electrically connected with the main body through an end of the second function module.

2. The Internet telephone according to claim 1, wherein the first function section comprises a dial key.

3. The Internet telephone according to claim 2, wherein the second function section comprises an input interface.

4. The Internet telephone according to claim 3, wherein the input interface is selected from the group consisting of a QWERTY keyboard, a touchpad, a direction key and a combination thereof.

5. The Internet telephone according to claim 1, wherein the second function section comprises a mini USB port.

6. The Internet telephone according to claim 1, wherein the second function section comprises a solid hard disk.

7. The Internet telephone according to claim 1, wherein the function module comprises a plurality of connection pins, and the connection pins are disposed at the side and the other side of the function module, respectively.

8. The Internet telephone according to claim 7, wherein the connection pins comprise at least one fool-proof pin for distinguishing the first function section from the second function section.

9. The Internet telephone according to claim 1, wherein the Internet telephone further comprises an antenna module, the main body comprises a slot, and the antenna module is assembled into the slot.

10. The Internet telephone according to claim 9, wherein the antenna module is a wireless receiving module.

11. The Internet telephone according to claim 10, wherein the antenna module comprises a wireless local area network (LAN) antenna module.

12. The Internet telephone according to claim 10, wherein the antenna module comprises a global positioning system (GPS) antenna module.

13. The Internet telephone according to claim 10, wherein the antenna module comprises a bluetooth transmission antenna module.

14. The Internet telephone according to claim 9, wherein the antenna module comprises a camera.

15. The Internet telephone according to claim 9, wherein the Internet telephone further comprises a fastener disposed at one side of the slot for fastening the antenna module to the slot.

16. The Internet telephone according to claim 1, wherein the Internet telephone further comprises a fastener disposed at one side of the recess for fastening the function module to the recess.

17. The Internet telephone according to claim 1, wherein the recess comprises at least one sliding rail.

18. The Internet telephone according to claim 17, wherein the function module comprises at least one sliding block sliding along the sliding rail.
